(19) United States
(12) Patent Application Publication
(10) Pub. No.: US 2014/0040448 A1
(43) Pub. Date: Feb. 6, 2014

(54) METHOD AND SYSTEM OF TURN ON/OFF EXECUTION FOR SERVERS

(71) Applicant: WISTRON CORPORATION, New Taipei City (TW)

(72) Inventors: Chien-Cheng CHENG, New Taipei City (TW); Hsin-Chieh YANG, New Taipei City (TW); Kuan-Lin LIU, New Taipei City (TW); Gang TANG, New Taipei City (TW)

(73) Assignee: Wistron Corporation, New Taipei City (TW)

(21) Appl. No.: 13/857,346

(22) Filed: Apr. 5, 2013

(30) Foreign Application Priority Data
Aug. 3, 2012 (CN) 201210274712.3

(51) Int. Cl. H04L 12/24

(52) U.S. Cl. CPC H04L 41/50
USPC 709/223

(57) ABSTRACT

A method of turn on/off execution for servers is disclosed. The method is used for controlling a plurality of first servers to turn on or turn off and includes the following steps: receiving a trigger signal; detecting whether all of the first servers are turned off; controlling the first servers to respectively transmit a turn on request signal if all of the first servers are turned off; receiving the turn on request signal and controlling each of the first servers to sequentially turn on by sending a permission signal to each of the first servers.

### BACKGROUND OF THE. INVENTION

1. Field of the Invention

The present invention is related to a method and a system of turn on/off execution for servers, and especially to a method and a system for controlling multiple servers to execute a turn on process or a turn off process.

2. Background

With the development of technology and changes in society, the world is now entering the network age. More and more shopping, entertainment or commercial activities are performed over networks. To instantly process information from local area networks or the Internet, many companies need to run numerous servers. Currently, most companies dispose multiple servers in a server rack so that the servers can share the same power source. In addition, to prevent overheating of the servers, there is usually a fan device for cooling the servers.

However, because the fan device is consumable, the fan device may malfunction with prolonged use; the fan power may decrease or other problems may occur, and the fan device then will need to be replaced or fixed.

Today, servers need to be turned off before the corresponding backside easy detachable fans can be replaced. However, the power switches of most current servers are on the front side of the server racks, and one fan system is usually used for supplying multiple servers. Therefore, an operator needs to go to the front side of the server rack to turn off each of the servers one by one before returning to the back side of the server rack to replace the fan device. Because the server rack has a certain length, such a replacement step is inconvenient for the operator.

To solve this problem, a remote control system has been developed to operate the on/off status of the servers. With this system, an operator does not need to turn off each server in the front of the server racks and only needs to issue commands to turn off the servers with instructions. The method may eliminate the time spent on walking by the operator, but the operator still needs to command the servers in a network control center to turn off one by one with instructions. When there are many servers, such a task can be time-consuming. In addition, when the operator walks to the back side of a server rack to replace a fan device and then finds that some servers have not turned off, the operator needs to walk back to the network control center to handle the issue. Such an inefficient use of time can cause the operator a great deal of inconvenience.

### SUMMARY OF THE INVENTION

It is a primary object of the present invention to provide a method for controlling multiple servers to turn on or turn off simultaneously, and for controlling each server to turn on sequentially when the servers are to be powered on.

It is another object of the present invention to provide a system of turn on/off execution for servers.

To achieve the above object, the method of turn on/off execution for servers is used for controlling a plurality of first servers to turn on or to turn off. The first servers are electrically connected to a power supply system. The method of turn on/off execution for servers includes the following steps: receiving a trigger signal requesting the plurality of first servers to turn on or to turn off; detecting whether the plurality of first servers are all turned off; if the plurality of first servers are all turned off, transmitting a turn on control signal to each of the first servers so that the plurality of first servers respectively transmit a turn on request signal; receiving the turn on request signal and determining whether other first servers other than the first server that transmits the turn on request signal turn on within a predetermined time period; if the other servers other than the first server that transmits the turn on request signal do not turn on within the predetermined time period, sending a permission signal to the first server that transmits the turn on request signal so that the first server that transmits the turn on request signal executes a turn on process; otherwise, if the other first servers other than the first server that transmits the turn on request signal turn on within the predetermined time period, then not sending the permission signal so that the first server that transmits the turn on request signal stays the execution of the turn on process.

To achieve another objective of the present invention, the system of turn on/off execution for servers of the present invention is used for controlling a plurality of first servers to turn on or to turn off. The first servers are electrically connected to a power supply system. The system of turn on/off execution for servers of the present invention includes a control module and a power monitor module. The control module is used for receiving a trigger signal requesting the plurality of first servers to turn on or turn off, and detecting whether the plurality of first servers are all turned off. When the control module receives the trigger signal and the plurality of first servers are all turned off, the control module transmits a turn on control signal to each of the first servers so that the plurality of first servers respectively transmit a turn on request signal. The power monitor module is used for receiving the turn on request signal, and after the turn on request signal is received, the power monitor module determines whether other first servers other than the first server that transmits the turn on request signal turn on within a predetermined time period. If the other first servers other than the first server that transmits the turn on request signal do not turn on within the predetermined time period, the power monitor module sends a permission signal to the first server that transmits the turn on request signal so that the first server that transmits the turn on request signal executes a turn on process.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a system diagram of a system of turn on/off execution for servers of the present invention.

FIG. 2 illustrates the appearance of a server rack.

FIG. 3 illustrates a backside switch device of the present invention.

FIG. 4 illustrates a flowchart of the method of turn on/off execution for servers of the present invention.

### DETAILED DESCRIPTION OF THE PREFERRED EMBODIMENT

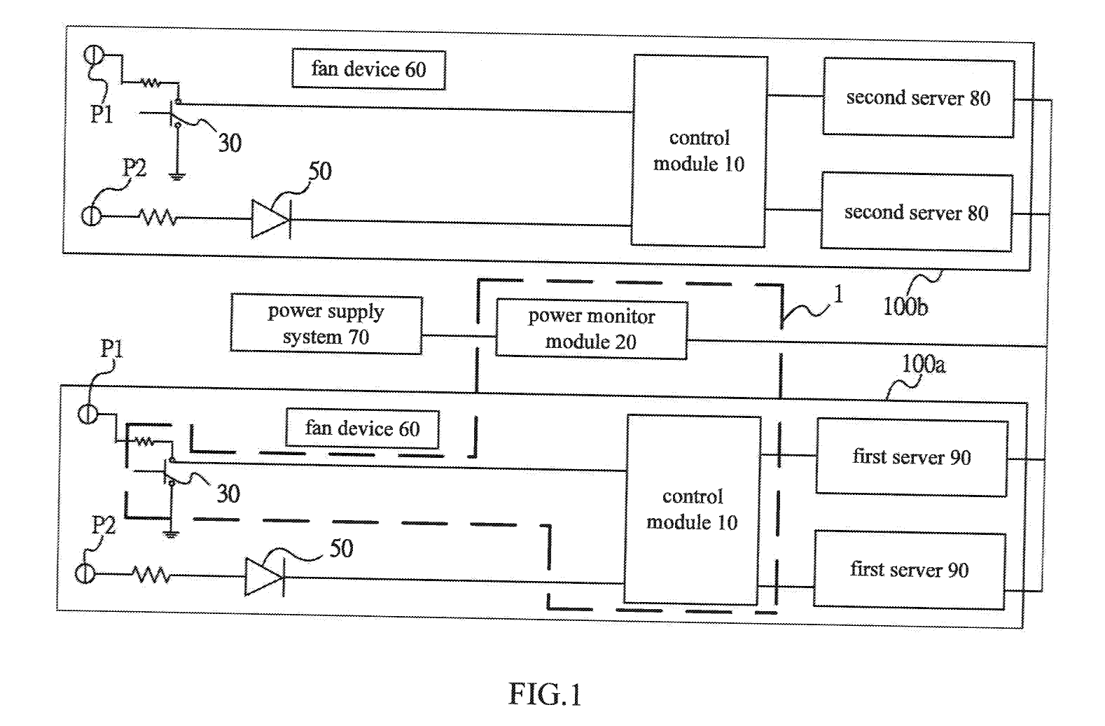

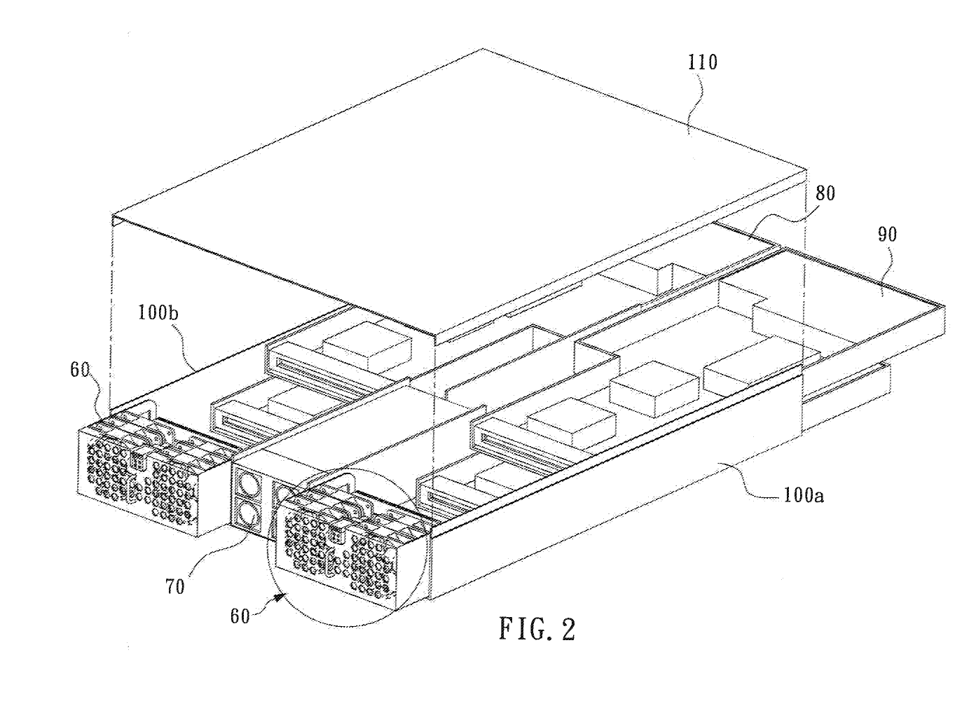

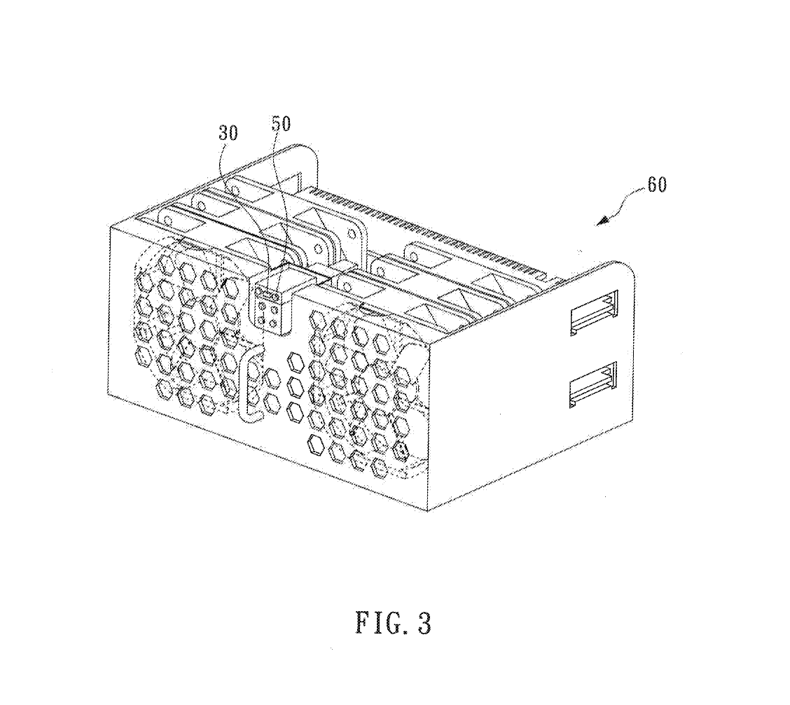

Please refer to FIG. 1 to FIG. 3. FIG. 1 illustrates a system structure diagram of a system of turn on/off execution for servers. FIG. 2 illustrates an appearance diagram of a server rack. FIG. 3 illustrates a backside switch device of the present invention.

As illustrated in FIG. 1, the system of turn on/off execution for servers 1 of the present invention is used for controlling a plurality of first servers 90 to turn on or turn off. In a specific embodiment of the present invention, the first servers 90 are disposed in a server rack 100a and are disposed in the front side of the server rack 100a. The server rack 100a is aligned with another server rack 100b, and a cover 110 covers the top of these two server racks. The server rack 100b is disposed with at least one second server 80. The first servers 90 and the at least one second server 80 are together electrically connected to the same power supply system 70 so that the power supply system may provide power to the first servers 90 and the second server 80 at the same time. In an example of the embodiment, the number of first servers 90 and the at least one second server 80 respectively is two, but the present invention is not limited to such a configuration.

In an embodiment of the present invention, the system of turn on/off execution for servers 1 includes a control module 10, a power monitor module 20 and a backside switch device 30.

The backside switch device 30 is disposed in the back side of the server rack 100a. As illustrated in FIG. 2 and FIG. 3, in a specific embodiment, a fan device 60 is detachably connected to the server rack 100a. The backside switch device 30 is electrically connected to the control module 10 for generating a trigger signal requesting the first servers 90 to turn on or to turn off.

As illustrated in FIG. 1, in an embodiment of the present invention, the control module 10 is electrically connected to the first servers 90. The control module 10 is used for receiving the trigger signal and detecting the current turn on and turn off status of the first servers 90 so that the control module 10 controls each of the servers to turn on or turn off according to status of the first servers after receiving the trigger signal. When all of the first servers 90 are turned off, the control module 10 allows a warning device 50 to generate a warning signal. In a specific embodiment of the present invention, the control module 10 may be a programmable firmware device, but the present invention is not limited to such a configuration. The control module 10 may also be implemented as a hardware device, a software program, electronic circuits, or other proper forms. In a specific embodiment of the present invention, the warning device 50 is a light emitting diode (LED), but the present invention is not limited to such a configuration.

In an embodiment of the present invention, the power monitor module 20 is electrically connected to the power supply system 70, to each of the first servers 90, and to each of the second servers 80. The power monitor module 20 is used for receiving a turn on request signal transmitted from each of the first servers 90. After receiving the turn on request signal, the power monitor module 20 determines whether the first servers 90 can be allowed to execute a turn on process according to the usage state of the power supply system 70 to prevent multiple first servers 90 or second servers 80 from being turned on at the same time or within a short time period, which may cause that an instant current supplied by the power supply system 70 is larger than an over current protection value of the power supply system 70 and thus the power supply system 70 stops providing power due to over current protection. In an example of the embodiment, the power monitor module 20 may be implemented by a programmable firmware device, but the present invention is not limited to such a configuration.

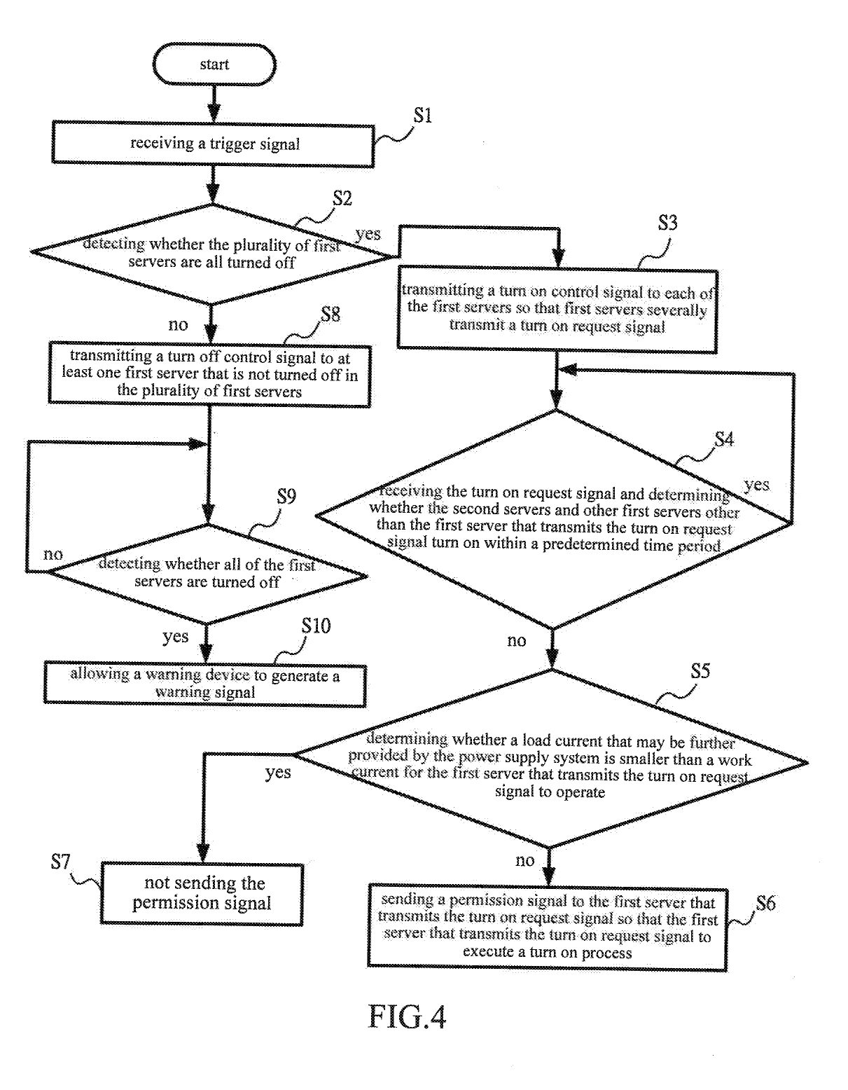

Next, please refer to FIG. 4 and FIG. 1 at the same time. FIG. 4 illustrates a flowchart of the method of turn on/off execution for servers of the present invention. It is to be noted that although the aforementioned the system of turn on/off execution for servers 1 is used as an example for illustrating the method of turn on/off execution for servers, the method of turn on/off execution for servers is not limited to being applied in the aforementioned the system of turn on/off execution for servers 1.

Firstly, step S1: receiving a trigger signal.

As illustrated in FIG. 1, in an embodiment of the present invention, an operator may press the backside switch device 30 in the back side of the server rack 100a to generate a trigger signal requesting the plurality of first servers 90 to turn on or to turn off. In an example of the embodiment, when the backside switch device 30 conducts, a current generated by a first direct current source P1 is transmitted to the control module 10. After the operator presses the backside switch device 30, the current generated by the first direct current source P1 is directed to ground. Therefore, after the backside switch device 30 is pressed, the control module 10 receives a trigger signal transformed from a high level to a low level.

Next, step S2: detecting whether the plurality of first servers are all turned off.

The control module 10 of the present invention may be used for detecting the status of turn on and turn off of the plurality of first servers 90. After the control module 10 receives the trigger signal, the control module 10 determines whether all of the first servers 90 have been turned off so that the first servers 90 may execute turn on/off.

Step S3: transmitting a turn on control signal to each of the first servers so that first servers severally transmit a turn on request signal.

After the step S2 is executed, if the control module 10 detects that each of the first servers 90 has been turned off, the control module 10 transmits a turn on control signal to each of the first servers 90 so that first servers 90 severally transmit a turn on request signal. In an example of the embodiment, each of the first servers 90 may be disposed with a programmable chip that has an output pin for transmitting the turn on request signal after receiving the control signal from the control module 10.

Step S4: receiving the turn on request signal and determining whether the second servers and other first servers other than the first server that transmits the turn on request signal turn on within a predetermined time period.

In a specific embodiment of the invention, the power monitor module 20 receives the turn on request signal from each of the first servers 90. Because the power supply system 70 is used for simultaneously supplying power to the first servers 90 and the second servers 80, if the power monitor module 20 receives the turn on request signal, the power monitor module 20 determines whether the second servers 80 and other first servers 90 other than the first server 90 that transmits the turn on request signal turn on within a predetermined time period so as to prevent multiple servers from executing a turn on process at the same time or within a short time period. Referring to FIG. 1 as an example, if the turn on request signal of the first server 90 in the top side of FIG. 1 is firstly transmitted to the power monitor module 20, the power monitor module 20 determines whether the second servers 80 and the first server 90 in the bottom of FIG. 1 turn on within a predetermined time period. Then, when the turn on request signal of the first server 90 in the bottom of FIG. 1 is transmitted to the power monitor module 20, the power monitor module 20 also determines whether the second servers 80 and the first server 90 in the top side of FIG. 1 turn on within the predetermined time period. If there is no other first server 90 and none of the second servers 80 turn on within the predetermined time period (e.g. 30 seconds), step S5 is executed. If there are other first servers 90 or the second servers 80 turn on within the predetermined time period, the first server 90 that transmits the turn on request signal stays the execution of a turn on process.

Step S5: determining whether a load current that may be further provided by the power supply system is smaller than a work current for the first server that transmits the turn on request signal to operate.

When the turn on request signal of the first server 90 is received and the second servers 80 and the other first servers 90 other than the first server 90 that transmits the turn on request signal do not turn on within the predetermined time period, the power monitor module 20 further determines whether a load current that can be further provided by the power supply system 70 is smaller than a work current for the first server 90 that transmits the turn on request signal to operate. For example, when the power monitor module 20 receives the turn on request signal transmitted from the first server 90 in the top side of FIG. 1, and it is determined that there is no other server executing the turn on process within the predetermined time period, the power monitor module 20 determines whether the load current that can be further provided by the power supply system 70 is able to satisfy the work current for the first server 90 in the top side of FIG. 1 to operate.

Step S6: sending a permission signal to the first server that transmits the turn on request signal so that the first server that transmits the turn on request signal executes a turn on process.

If the power monitor module 20 receives the turn on request signal from one of the first servers 90 and determines that second servers 80 and other first servers 90 other than the first server 90 that transmits the turn on request signal do not turn on, and the power supply system 70 is able to provide a load current that is not smaller than the work current for the first server that transmits the turn on request signal to operate, the power monitor module 20 sends a permission signal to the first server 90 that transmits the turn on request signal so that the first server 90 executes a turn on process according to the permission signal.

Step S7: not sending the permission signal.

On the other hand, if the load current that can be further provided by the power supply system 70 is smaller than the work current for the first server 90 that transmits the turn on request signal to operate, the power monitor module 20 does not send the permission signal to the first server 90 so that the first server 90 does not execute the turn on process to protect the power supply system 70.

Step S8: transmitting a turn off control signal to at least one first server that is not turned off in the plurality of first servers.

After step S2 is executed, if the plurality of first servers 90 are not all turned off, the control module 10 transmits a turn off control signal to at least one first server that is not turned off in the plurality of first servers 90 to control the at least one first server 90 to turn off. For example, if the first server 90 in the top side of FIG. 1 is not turned off but the first server 90 in the bottom of FIG. 1 is turned off, the control module 10 only transmits the turn off control signal to the first server 90 in the top side of FIG. 1 to control the first server 90 to turn off If both of the first servers 90 are turned on, the control module 10 respectively transmits the turn off control signal to each of the first servers 90.

Step S9: detecting whether all of the first servers are turned off

The control module 10 continuously detects the status of the first servers 90 to detect whether all of the first servers are turned off,

Step S10: allowing a warning device to generate a warning signal.

Once all of the first servers are turned off, the control module 10 controls a warning device 50 to generate a warning signal for informing an operator that each of the first servers in the server rack 100a has been turned off. In a specific embodiment of the invention, the warning device 50 is a light emitting diode. The light emitting diode is electrically connected to a second direct current source P2 and the control module 10. When the first servers 90 are not all turned off, the light emitting diode emits light by a forward bias generated by the second direct current source P2. Once the first servers 90 are all turned off, the control module 10 supplies the light emitting diode a reverse bias so that the forward bias is smaller than the reverse bias so that the light emitting diode no longer emits light (i.e., the warning signal). In addition to the light emitting diode no longer emitting light to show that the servers are all turned off, it can also be designed so that the light emitting diode emit lights or blinks to achieve a warning effect. All such variations depend on design requirements. It is to be noted that the method of turn on/off execution for servers of the present invention is not limited to the order of the aforementioned step orders. Any order of the steps that may achieve the objectives of the present invention is also adoptable; i.e., the order of the aforementioned steps may be changed.

With the method of turn on/off execution for servers of the present invention, on the servers can be turned on or turned off simultaneously. In addition, with the backside switch device 30, an operator only needs to operate on the back side of the server rack 100a, 100b when fixing the fan device 60 and does not need to go to a network control center or go to the front side of the server rack 100a, 100b after the operator is already on the back side of the server rack 100a, 100b if the operator finds that some servers have not been turned off.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method of turn on/off execution for servers, which is used for controlling a plurality of first servers to turn on or turn off, the plurality of first servers being electrically connected to a power supply system, the method comprising:
receiving a trigger signal requesting the plurality of first servers to turn on or turn off;
detecting whether all of the first severs are turned off;
if all of the first servers are turned off, transmitting a turn on control signal to each of the first severs so that each of the first servers transmits a turn on request signal;
receiving the turn on request signal and determining whether other first servers other than the first server that transmits the turn on request signal turn on within a predetermined time period;
if the other first servers other than the first server that transmits the turn on request signal do not turn on within the predetermined time period, sending a permission signal to the first server that transmits the turn on request signal so that the first server that transmits the turn on request signal executes a turn on process;
if the other first servers other than the first server that transmits the turn on request signal turn on within the predetermined time period, not sending the permission signal so that the first server that transmits the turn on request signal stays the execution of the turn on process.

2. The method of turn on/off execution for servers of claim 1, wherein before the step of sending the permission signal to the first server that transmits the turn on request signal, the method further comprises:
determining whether a load current further provided by the power supply system is smaller than a work current for the first sever that transmits the turn on request signal to operate;
if the load current is not less than the work current, sending the permission signal to the first server that transmits the turn on request signal so that the first server that transmits the turn on request signal executes the turn on process; and
if the load current is smaller than the work current, not sending the permission signal.

3. The method of turn on/off execution for servers of claim 2,wherein the power supply system is further electrically connected to at least one second server, and the step of determining whether the other first servers other than the first server that transmits the turn on request signal turn on within the predetermined time period further comprises:
determining whether the at least one second server turns on within the predetermined time period;
if the at least one second server does not turn on within the predetermined time period, sending the permission signal to the first server that transmits the turn on request signal so that the first server that transmits the turn on request signal executes the turn on process; and
if the at least one second server turns on within the predetermined time period, not sending the permission signal so that the first server that transmits the turn on request signal stays the execution of the turn on process.

4. The method of turn on/off execution for servers of claim 1, wherein after receiving the trigger signal, if the plurality of first servers are not all named off, the method further comprises:
transmitting a turn off control signal to at least one first server of the plurality of first servers that is not turned off so that the at least one first server executes a turn off process.

5. The method of turn on/off execution for servers of claim 4, wherein after the at least one first server executes the turn off process, the method further comprises:
detecting whether the plurality of first servers are all turned off, and
if all of the first servers are turned off, generating a warning signal by a warning device.

6. A system of turn on/off execution for servers, which is used for controlling a plurality of first servers to turn on or turn off, the plurality of first servers being electrically connected to a power supply system, the system of turn on/off execution for servers comprising:
a control module for receiving a trigger signal requesting that the plurality of first servers turn on or turn off, and detecting whether all of the first servers are turned off, wherein the control module transmits a turn on control signal to each of the first servers when the control module receives the trigger signal and all of the first servers are turned off, so that each of the first servers transmits a turn on request signal; and
a power monitor module for receiving the turn on request signal and determining whether other first servers other than the first server that transmits the turn on request signal turn on within a predetermined time period, wherein the power monitor module sends a permission signal to the first server that transmits the turn on request signal when the other first servers other than the first server that transmits the turn on request signal do not turn on within the predetermined time period, so that the first server that transmits the turn on request signal executes a turn on process.

7. The system of turn on/off execution for servers of claim 6, further comprising a backside switch device electrically connected to the control module for generating the trigger signal.

8. The system of turn on/off execution for servers of claim 7, wherein before the power monitor module sends the permission signal to the first server that transmits the turn on request signal, the power monitor module further determines whether a load current further provided by the power supply system is smaller than a work current for the first server to operate; when the load current is not smaller than the work current, the power monitor module sends the permission signal to the first server that transmits the turn on request signal; when the load current is smaller than the work current, the power monitor does not send the permission signal.

9. The system of u on/off execution for servers of claim 8, wherein the power supply system is electrically connected to at least one second server and when the power monitor module determines whether the other first servers other than the first server that transmits the turn on request signal turn on within the predetermined time period, the power monitor module further determines whether the at least one second server turns on within the predetermined time period.

10. The system of turn on/off execution for servers of claim 6, wherein after the trigger signal is received and the plurality of first servers are not all turned off, the control module further transmits a turn off signal to at least one first server of the plurality of first servers that is not turned off so that the at least one first server executes a turn off process.

11. The system of turn on/off execution for servers of claim 10, wherein the control module allows a warning device to generate a warning signal after the plurality of first servers are all turned off.

12. The system of turn on/off execution for servers of claim 7, wherein the plurality of first servers are disposed in a front side of a server rack, and the backside switching device is disposed in a back side of the server rack.
